(19) United States
(12) Patent Application Publication
(10) Pub. No.: US 2008/0230527 A1
(43) Pub. Date: Sep. 25, 2008

(54) Method of manufacturing an exhaust gas manifold utilizing hybrid MIG welding

(76) Inventors: Haimian Cai, Ann Arbor, MI (US); William R. Koivula, Milford, MI (US); Baoluo Chen, Rochester Hills, MI (US)

Correspondence Address: AUTOMOTIVE COMPONENTS HOLDINGS LLC;C/O MACMILLAN, SOBANSKI & TODD, LLC, ONE MARITIME PLAZA, FIFTH FLOOR, 720 WATER STREET, TOLEDO, OH, 43604-1853, US

(21) Appl. No.: 11/725,415

(22) Filed: Mar. 19, 2007

(51) Int. Cl. B23K 9/02

(52) U.S. Cl. 219/137 R

(57) ABSTRACT

A method of manufacturing an exhaust gas manifold, that includes metal exhaust pipes and metal flanges for attaching the pipe openings to corresponding internal combustion engine exhaust ports, employs a hybrid MIG welding process to reduce the occurrences of weld spatter being deposited on the pipe surfaces. Additional benefits are a reduction in applied energy, a resultant reduction in heat being applied to the work pieces, less consumption of weld wire, and improved efficiency of making the weld on the inside surface of the flange adjacent to the pipe opening. The hybrid MIG technique involves moving the head of the weld gun so that its weld wire tip is in contact with the closed path joint formed between an aperture in the flange and the pipe opening. Electrical energy is then applied between the weld wire and the work pieces (flange and pipe) for a relatively short period of time that is sufficient to cause the tip of the weld wire to become a molten drop. When the molten weld material is formed, the application of electrical energy is terminated and the weld wire is retracted or withdrawn away from contact to allow the molten wire drop to enter the joint and form the weld. The weld head is then moved with respect to its current location with respect to the work piece and the weld steps are repeated at a predetermined rate at each point along the joint to complete the weld between the pipe opening and the flange.

### BACKGROUND OF THE INVENTION

The invention relates generally to the field of manufacturing automotive components and more specifically to a method of welding components included in exhaust manifold for an automotive vehicle.

The exhaust manifold is a key component of an internal combustion engine exhaust system for an automotive vehicle. The manifold provides an interface between the engine and the exhaust system. It also provides a passage for all the exhaust gases created by the engine for conveying them into an exhaust pipe, followed by a catalytic converter, muffler and tail pipe. Because a manifold has to be attached to the cylinder head of an engine and capture exhaust gases from each of the individual engine exhaust ports, the design and number of exhaust pipes used in manifolds usually correspond to the number of exhaust ports. Attachment of the manifold to the engine is usually made by threading bolts extending through holes in the flanges that are welded to the openings of the pipes.

Typical exhaust manifolds are made from cast iron although some high performance exhaust manifold designs make use of tubular steel for their construction. Most exhaust manifolds are also designed with smooth curves so that the exhaust gases flow more efficiently.

Traditionally, Metal Inert Gas (MIG) or Tungsten Inert Gas (TIG) welding methods are used for welding flanges to the exhaust pipes (tubes) in the process of manufacturing an exhaust gas manifold assembly.

Welding together the components of a manifold assembling may seem to be quite straight forward, since the components are all made of steel metal. However, traditional MIG and TIG welding methods are well known to present several disadvantages.

One disadvantage is that welding material spatters away from the weld joint and tends to stick to the surfaces of the manifold exhaust pipes (tubes). If spatter material enters a pipe opening, it often becomes deposited on the inner surface of the pipe. In order to remove the spatter, costly and time consuming cleaning operations are required. If not completely removed, small pieces of the spatter material may become dislodged at some later time and may adversely effect the engine and/or exhaust system performance.

FIG. 1 illustrates a typical exhaust gas manifold 100 in which flanges 112, 114 and 116 are welded to exhaust pipe 102, 104 and 106, respectively. In the example shown, the exhaust manifold assembly 100 serves one bank of cylinders of a V-8 type engine (not shown). The central pipe 106 extends from the middle of a yoke element 101 and is configured to cover two exhaust ports, while pipes 102 and 104 cover separate exhaust ports. The flange welds 122, 124 and 126 are each made to the joint formed at the outside surfaces of the respective pipes and flanges.

A significant disadvantage in performing an outside weld is that the weld head must follow an interrupted path and be reoriented to weld the joint. As seen in FIG. 1, due to the configuration of the pipe 102 and the remainder of the assembly, either two weld heads must be used from opposite angles or a single weld head must be reoriented with respect to the joint at least once in order to complete a continuous weld 122. Similarly, interrupted paths and change of orientation must occur to complete the other welds 124 and 126. Such duplication of weld heads or reorientation of a single weld head adds to the time and complexity of making the welds and adversely impacts the cost of manufacturing the manifold assembly.

If one were to try a traditional MIG or TIG weld method on the inside of a flange 110 at pipe opening 111 as illustrated in FIGS. 2A-2D, significant spattering 225 would be deposited on the inner surface of the pipe 103. In order to reduce the effects of spattering, it has been viewed as more advantageous to weld the joint formed between the outer surface 112 of a flange 110 and the outer surface of a pipe 102, as shown in FIG. 1. Even though an outside weld produces less spattering to be deposited inside the pipe, there is still a tendency for some weld material to migrate through the air gap at the joint and enter the pipe opening as spatter.

A further disadvantage in using a conventional welding process to weld manifold pipes to flanges is the potential for introducing an excessive amount of heat to the zone surrounding the weld areas. Excessive heat may cause burn-through at the welding area and/or other dimensional distortions between the pipe and the flange. Any dimensional distortion of a flange may adversely affect the seal created between the cylinder head surrounding the engine exhaust port and the flange or between the exhaust pipe and the flange and provide a point of exhaust gas leakage during usage.

Still further disadvantages of using the conventional welding process are that it is relatively slow and utilizes excessive amounts of weld material and electrical power that result in a higher cost to be incurred in the manufacturing process.

### SUMMARY OF THE INVENTION

The present invention utilizes a hybrid MIG welding method to weld the exhaust pipes (tubes) to manifold flanges during the exhaust manifold manufacturing process. The weldings are performed on the inside surfaces of the flanges adjacent the pipe openings.

The hybrid MIG welding method controls voltage, current and weld wire motion to make a weld that is substantially spatter-free and overcomes the problems known in conventional MIG welding methods. The hybrid MIG welding method also produces a smaller welding zone than traditional welding. A smaller welding zone reduces the amount of welding wire consumption, increases the welding speed, and reduces the amount of heat introduced to the surrounding area. Overall, the hybrid MIG welding method applied to manifold components results in the reduction of welding spatter and other heat related distortions that are seen as undesirable.

Because the hybrid MIG welding method has the advantages stated above, we now have the ability to make a continuous weld on the joint formed between the inside surfaces of the flanges and adjacent to the pipe openings. The result, compared with conventional welding on the outside surface of the flange means that a welding head can now be controlled along a more efficient continuous closed weld path.

It is therefore an object of the present invention to provide an improved method of welding flanges to the openings of exhaust pipes in an exhaust gas manifold by utilizing a hybrid MIG welding process.

It is another object of the present invention to provide an improved method of welding flanges to pipes in an exhaust gas manifold in such a way as to significantly reduce the occurrences and effects of spattering.

It is a further object of the present invention to provide an improved method of welding flanges to pipes in an exhaust gas manifold in such a way as to significantly reduce the distortion effects of excessive heat from traditional welding methods.

It is a still further object of the present invention to provide an improved method of welding flanges to pipes in an exhaust gas manifold that gains efficiencies that include less electrical energy, less consumable materials and increased through-put do to less handling and faster welding.

### BRIEF DESCRIPTION OF THE DRAWINGS

FIG. 1 is a perspective view of a typical exhaust gas manifold assembly shown with a conventional MIG weld made to the outside surface of the pipes and flanges.

FIGS. 2A-2D illustrate steps in the process of trying to apply a conventional MIG welding process to the inside surface of the flange and pipe opening of an exhaust manifold assembly and the typical result.

FIG. 3 is a wave diagram showing the typical voltage application for a conventional MIG welding.

FIG. 4A is a cross-sectional view of a flange and pipe of an exhaust gas manifold assembly in which a hybrid MIG weld is applied to the inside surface of the flange adjacent the pipe opening.

FIG. 4B is a plan view of the components shown in FIG. 4A.

FIGS. 5A-5C illustrate steps in the process of utilizing the hybrid MIG weld method to the inside surface of the flange and pipe opening of an exhaust manifold assembly of the present invention.

FIG. 6 is a wave diagram showing the voltage application cycles for the hybrid MIG weld method as employed in the present invention.

### DETAILED DESCRIPTION OF THE PREFERRED EMBODIMENTS

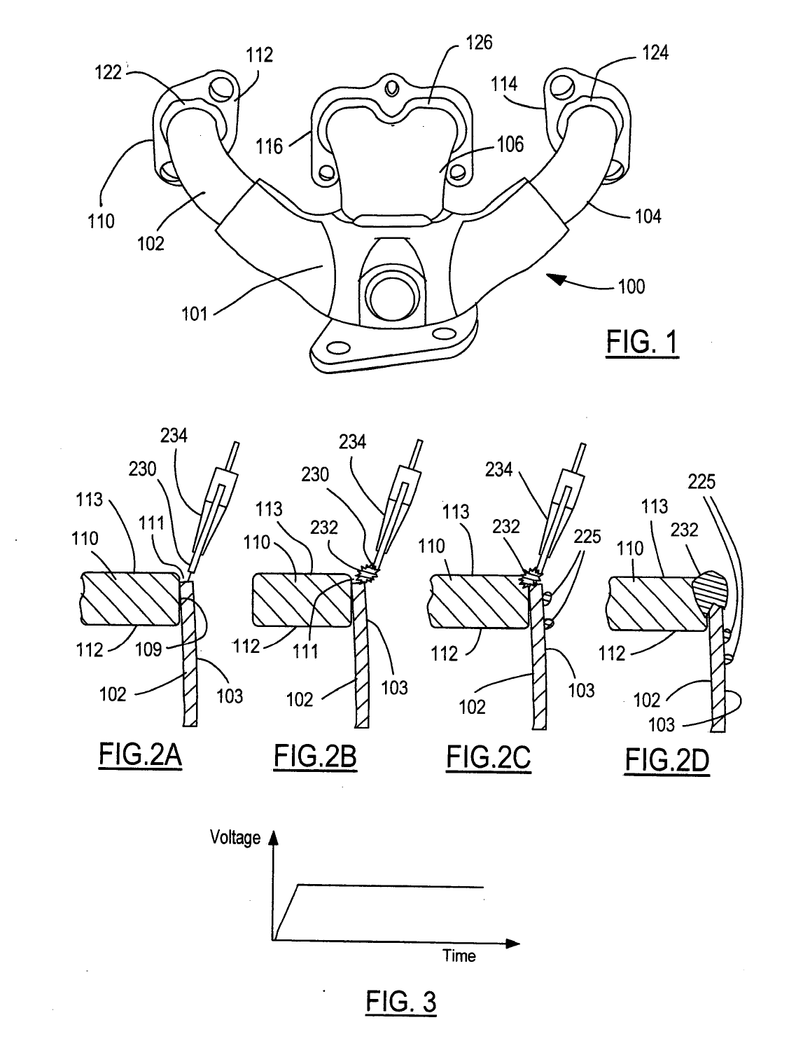

A typical exhaust gas manifold assembly 100 is shown in FIG. 1 as including exhaust pipes 102 and 104 that extend from either side of a central yoke 101. A pair of additional pipes 106 is formed to extend from the center of yoke 101. Each pipe end has an opening which corresponds in location, when installed on an internal combustion engine (not shown), with the engine exhaust ports. The manifold receives exhaust gases and passes them to the exhaust system (not shown) which typically includes a catalytic converter, a muffler and exhaust pipe to transport the exhaust gases way from the engine. Flanges 112, 114 and 116 are shown associated with pipes 102, 104 and 106, respectively. The flanges are welded to the ends of the pipes and provide a connecting interface between the engine and the manifold assembly. Each flange has a pair of apertures through which bolts are inserted and tightened to the engine. Typically, the surface of the engine adjacent each exhaust port and the inner surface of each flange is relatively smooth so that when the flange is bolted to the engine, the connection is sealed tight.

In the typical exhaust gas manifold 100, the flanges are attached to the pipe ends by using a conventional MIG or TIG welding process. Because of the high spatter properties inherent in the conventional MIG or TIG welding process, welds 122, 124 and 126 are made to the outside of the joints between the pipes and the flanges.

It would be preferable to make such welds on the inside joints formed between the pipe ends and the flange openings as shown in FIGS. 2A-2D. Such inside welding would allow the weld head 234 to track a continuous weld path around the circular joint and add efficiencies to the weld step in the manufacturing process. However, if one were to use a conventional MIG or TIG weld process, high amounts of spatter would occur and be deposited on the inner surface 103 of the pipe. The conventional MIG weld steps are discussed below in conjunction with FIGS. 2A-2D and FIG. 3 as background for describing the present invention.

An example of the conventional MIG weld is applied to a joint formed between the inside surface of the aperture 109 formed in flange 110 and the open edge 111 of pipe 102. In this example, the weld head is shown in FIG. 2A-2C as containing a weld wire 230 that is advanced through the weld head from a spool supply (not shown). When positioned in contact with the joint between aperture surface 109 and open edge 111, as represented in FIG. 2A, voltage is applied between the weld wire and the metal components for a continuous period of time while the weld wire is fed and the head is moved along the joint. The application of voltage is represented in the wave form shown in FIG. 3. Since the objective is to achieve a continuous weld of the circular joint, the length of the time the voltage is applied corresponds to the amount of time it takes for the weld to be completed around the circular joint. When the voltage is applied, the tip of the weld wire 230 liquefies due to the heat generated at the contact point of the wire to the metal work piece (flange and pipe) and forms a weld bead 232, as is represented in FIG. 2B. Of course, the continuous application of voltage and melting of the wire introduces continuous heat to the work piece and requires aggressive heat sinking techniques in order to avoid distortion effects to the work pieces. As the weld head 234 is continued to be moved along the closed weld path, weld wire 230 is continued to be advanced and fed to supply weld material to the joint, as is represented in FIG. 2C.

In FIGS. 2C and 2D, a large weld bead 232 and spatter material 225 is represented as having been produced by the conventional MIG welding process. Spatter 225 is illustrated as several globular bits having been deposited on the inner surface 103 of pipe 102. While there are only a few spatter bits depicted in this cross-sectional view, the spatter is essentially spread over the entire inner surface 103 of pipe 102 near opening 111, and often beyond.

In contrast, the present invention achieves the advantages and objectives recited in the Summary of the Invention section above by utilizing a hybrid MIG welding process to weld flanges onto the open intake ends of manifold pipes.

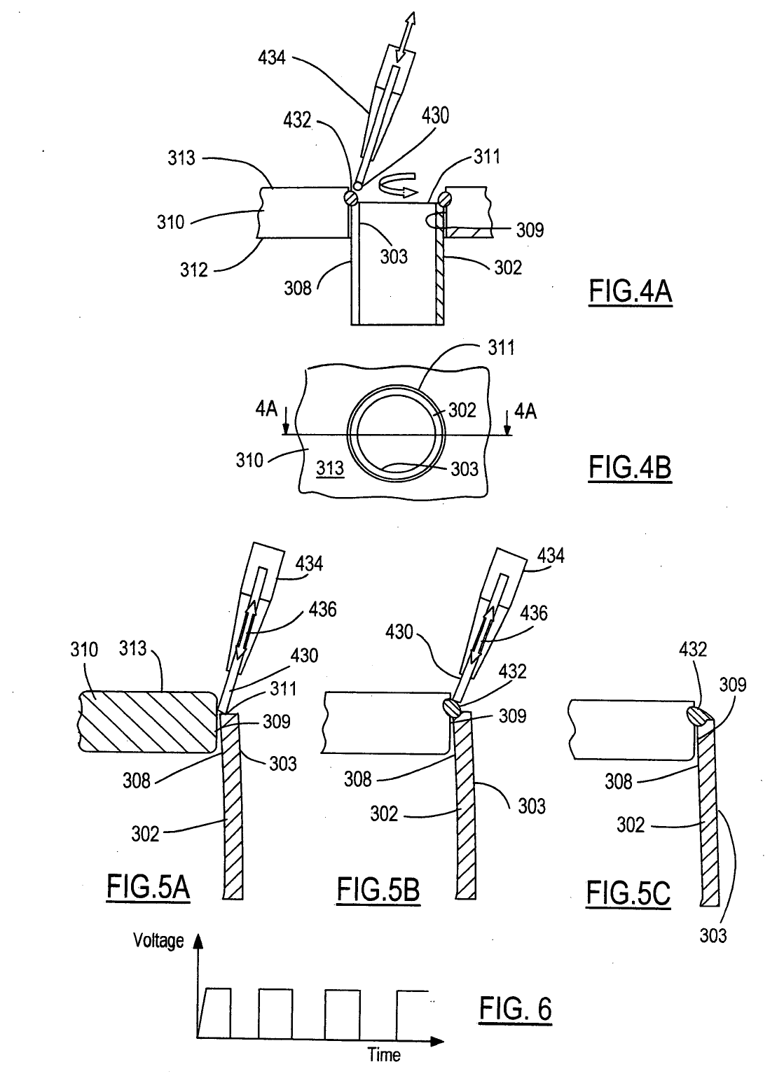

In FIGS. 4A and 4B, the relative positions of a pipe 302 and flange 310 are illustrated to show the closed weld path followed by the weld head 434. When beginning the hybrid MIG welding process, the flange 310 and the pipe 302 are positioned and retained as shown in FIGS. 4A and 5A. The inner surface 313 of flange 310 is oriented to face towards the weld head 434, and the open end 311 of pipe 302 pipe is located within the aperture 309. The outer surface 308 of pipe 302 is adjacent the surface of the aperture 309 and due to the tolerances, may be either tightly fitted or separated by a small gap. The relative positions of the flange inner surface 313 and the open end 311 are such that a small step is formed around the joint between the open end 311 and the inside surface of the aperture 309. This provides surface area for the weld to be formed for added strength.

As shown in FIG. 5A, weld head 434 of the welding gun is controllably positioned to allow the weld wire 430 to be advanced from the head sufficiently to have the tip contact the joint formed between the pipe and the flange. When positioned, voltage is applied between the weld wire and the work piece as a relatively short pulse and the tip of weld wire 430 instantly melts to form a small weld bead 432 as shown in FIG. 5B. At the end of the short pulse of voltage, the weld wire 432 is retracted and withdrawn to eliminate contact with the bead 432. The bead 432, in its molten state, fuses with the metal forming surfaces at 309 and 311, as shown in FIG. 5C.

The weld head 434 is then moved to a position that allows for the next weld to be placed adjacent to the prior weld. These steps are repeated over the closed weld path until the entire joint between the pipe and the flange is completed. The steps are repeated at a rate that corresponds to the rate of voltage application illustrated in the pulsed wave form illustrated in FIG. 6. This is usually on the order of a range of from 1-100 Hz, but may become faster as welding control equipment is improved.

The important results of this invention are the reduction and substantial elimination of spatter and reduction in heat. As illustrated in FIGS. 5B and 5C, no significant spatter material is deposited on the inner surface 303 of the pipe 302 as a result of employing this Hybrid MIG welding process. Since the heat generated from this hybrid MIG welding process is generated in short and controlled pulse steps, there is a cooling period allowed to take place between each weld pulse. As compared to a conventional MIG welding process, which applies heat continuously during the weld, the use of this Hybrid MIG welding process provides a significant reduction in the heat that migrates into each flange and pipe that form the work piece.

It should be understood that the foregoing description of the embodiments is merely illustrative of many possible implementations of the present invention and is not intended to be exhaustive.

We claim:

1. A method of welding an exhaust gas manifold assembly comprising a metal exhaust pipe and a metal flange, said exhaust pipe being formed to have an open end that is positioned to communicate with the exhaust port of an internal combustion engine and allow exhaust gases from said engine to flow through said pipe, said flange being formed as a relatively flat metal element with inner and outer surfaces and a central aperture, being slightly larger than the outer diameter of said pipe at its opening, wherein said flange forms an interface for attachment between said pipe and said engine, said method comprising the steps of:
positioning and retaining said flange aperture whereby said aperture surrounds the end of said pipe to define a closed path joint adjacent the inner surface of said flange and said opening of said pipe;
positioning said retained flange and pipe to have said inner surface of said flange and said opening of said pipe both oriented to be accessible by a weld head;
utilizing a hybrid MIG welding process by moving the sacrificial wire weld tip of a weld gun into contact with the outer edge of said pipe opening and the aperture wall of said flange adjacent said joint;
applying a predetermined amount of electrical energy between said wire weld tip and said pipe and flange for a predetermined amount of time to create a molten drop of wire at said tip; terminating the application of electrical energy;
retracting back said weld wire tip to break said contact with said joint and allow said molten drop to enter into said joint and form said weld;
moving said wire weld tip to a point along said joint and directly adjacent said prior weld;
repeating said steps of contacting, applying and terminating electrical energy, and retracting said wire tip and moving said wire tip of said gun to adjacent points along said joint until said joint is welded along its entire closed path.

2. The method of claim 1, wherein said pipe opening is slightly below said inner surface of said flange to provide a step weld surface at said joint.

3. The method of claim 1 wherein, prior to said step of contacting, said weld wire in said weld head is controlled to be advanced a predetermined amount that corresponds to the amount of wire used in the immediately previous weld.

4. The method of claim 1 wherein said step of retracting includes the step of drawing the wire back into the weld head by a predetermined amount.

5. The method of claim 1 wherein said steps of contacting, applying and terminating electrical energy, retracting said wire tip and repositioning said wire tip of said gun to adjacent points along said joint are performed at a predetermined and periodic rate.

6. The method of claim 5 wherein said rate is in the range of approximately 1-100 Hz.

7. A method of welding a metal flange to an exhaust pipe of an exhaust gas manifold assembly comprising the steps of:
providing a metal exhaust pipe configured with an open end for surrounding an exhaust port of an internal combustion engine;
providing a metal flange configured to have an inner surface, an outer surface and a central aperture corresponding in shape to and slightly larger than the outer surface of said pipe at its open end;
retaining said flange and said pipe in a position to have said open end of said pipe inserted into said central aperture of said flange from said outer surface towards said inner surface to define a closed path joint on the inner side of said flange where said open end of said pipe abuts said flange;
performing a Hybrid MIG welding process by locating the weld wire tip of a weld gun into contact with the outer edge of said pipe opening and the aperture wall of said flange adjacent said joint; applying a predetermined amount of electrical energy between said wire weld tip and said pipe and flange assembly for a predetermined amount of time to create a molten drop of wire at said tip;
terminating the application of electrical energy;
retracting said weld wire tip to break said contact with said joint and allow said molten drop to enter into said joint and form said weld; and
moving said weld wire tip of a weld gun to a position adjacent said prior weld position and repeating said steps of contacting, applying and terminating electrical energy, retracting said wire tip and repositioning said wire tip of said gun to adjacent points along said joint until said joint is welded along its entire closed path.

8. The method of claim 7, wherein said pipe opening is retained in a position slightly below said inner surface of said flange to provide a step weld surface at said joint.

9. The method of claim 7 wherein said steps of contacting, applying and terminating electrical energy, retracting said wire tip and repositioning said wire tip of said gun to adjacent points along said joint are performed at a predetermined and periodic rate.

10. The method of claim 9 wherein said rate is in the range of approximately 1-100 Hz.
